(19) United States
(12) Patent Application Publication
(10) Pub. No.: US 2005/0195961 A1
(43) Pub. Date: Sep. 8, 2005

(54) System, method and software for delivering targeted content to queued users

(75) Inventors: Theodore B. Pasquale, Austin, TX (US); Benjamin A. Knott, Round Rock, TX (US); Kurt M. Joseph, Austin, TX (US); Robert R. Bushey, Cedar Park, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P.

(21) Appl. No.: 10/793,002

(22) Filed: Mar. 4, 2004

(51) Int. Cl. H04M 3/00; H04M 5/00

(52) U.S. Cl. 379/265.02; 379/266.01

(57) ABSTRACT

A system, method and software for delivering targeted queue-time content are provided. In response to user selection of a transaction or information from a call center, content matched between the selected transaction and one or more items of information concerning the user are preferably compiled. During the period in which the user awaits service in a queue associated with a transaction agent or service module for the selected transaction, the matched data relating user specific information to the selected transaction is presented for user consumption and/or selection therefrom. The selection of an alternate transaction from within one queue may be enhanced by a repetition of the matching of user specific information with one or more aspects of the alternate transaction selection being compiled and presented to the user during a subsequent queued period associated with the alternate transaction selection.

### TECHNICAL FIELD OF THE INVENTION

The present invention relates generally to customer service delivery and, more particularly, to maximizing the utility of time spent queued for assistance.

### BACKGROUND OF THE INVENTION

Every year, call centers around the world receive millions of calls. Typically, a customer contacting a call center is routed to a service agent either through an interactive voice response system that is touchtone activated or speech enabled. In many instances, customer demand for services exceeds the availability of call center representatives resulting in frequently customer placement in waiting queues. In many waiting queues, music is played until a representative is available to take a holding call. Not surprisingly, many customer complaints arise from queue waiting times as such waiting is typically wasteful and often frustrating.

Given that technology to route calls via speech enabled systems is quickly replacing touchtone enabled systems, it now becomes possible to gain a better understanding of what a customer intends to accomplish when contacting a call center. A problem that often occurs, however, in speech enabled call routing systems is that customers are often not specific enough when requesting a transaction, stating their task or intent. In the end, customer frustration may be reduced and customer service improved by minimizing or at least producing in the customer's mind a perception of minimizing the time spent waiting in transaction queues.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a schematic diagram depicting one embodiment of a telecommunications system incorporating teachings of the present invention;

FIG. 2 is a schematic diagram depicting an alternate embodiment of a telecommunications system incorporating teachings of the present invention;

FIG. 3 is a schematic diagram depicting a further embodiment of a telecommunications system incorporating teachings of the present invention;

FIG. 4 is a block diagram depicting one embodiment of a speech enabled call center environment incorporating teachings of the present invention;

FIG. 5 is a flow diagram depicting aspects of one embodiment of a method for delivering task specific queue-time content to call center users incorporating teachings of the present invention; and

FIG. 6 is a flow diagram depicting alternative aspects of one embodiment of a method for presenting task specific queue-time content to call center users incorporating teachings of the present invention.

### DETAILED DESCRIPTION OF THE INVENTION

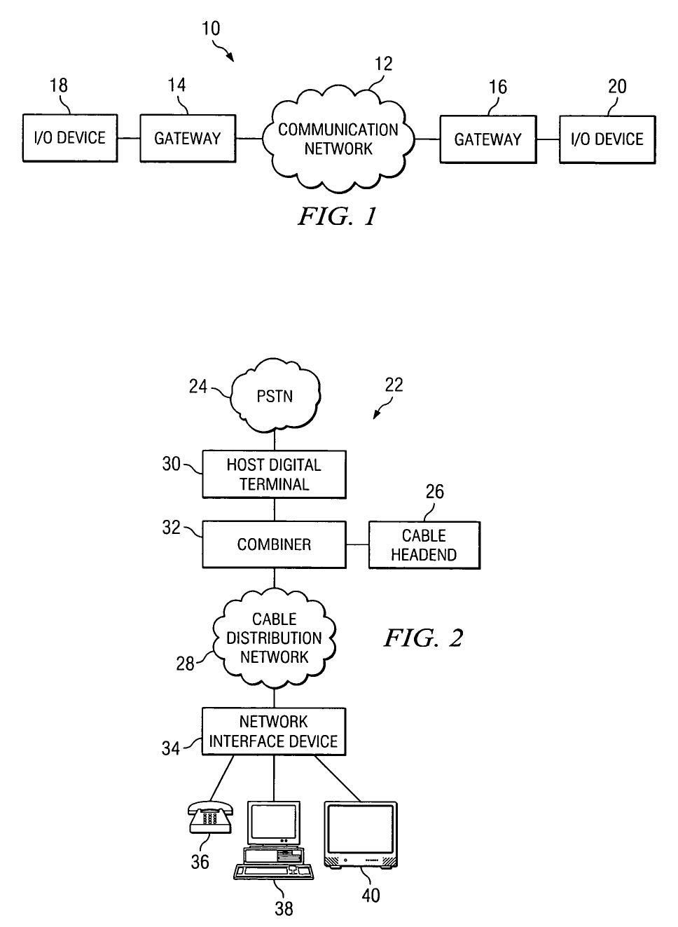

Preferred embodiments and their advantages are best understood by reference to FIGS. 1 through 6, wherein like numbers are used to indicate like and corresponding parts.

Referring first to FIG. 1, a schematic diagram of an exemplary embodiment of a telecommunications system, operable to communicatively connect a user and a call center, indicated generally at 10, is shown. Telecommunication system 10 may include communication network 12 in communication with one or more gateway devices 14 and 16. Input/output (I/O) devices 18 and 20 are each preferably in communication with respective gateway devices 14 and 16. Accordingly, I/O devices 18 and 20 may be in selective communication with each other via gateway devices 14 and 16, and communication network 12.

In one embodiment, communication network 12 may be a public switched telephone network (PSTN). In alternate embodiments, communication network 12 may include a cable telephony network, an IP (Internet Protocol) telephony network, a wireless network, a hybrid Cable/PSTN network, a hybrid IP/PSTN network, a hybrid wireless/PSTN network or any other suitable communication network or combination of communication networks.

Gateways 14 and 16 preferably provide I/O devices 18 and 20 with an entrance to communication network 12 and may include software and hardware components to manage traffic entering and exiting communication network 12 and conversion between the communication protocols used by I/O devices 18 and 20 and communication network 12. In some embodiments, gateways 14 and 16 may function as a proxy server and/or a firewall server for I/O devices 18 and 20. In some embodiments, gateways 14 and 16 may be associated with a router (not expressly shown) operable to direct a given packet of data that arrives at gateway 14 or 16, and a switch (not expressly shown), operable to provide a communication path in and out of gateway 14 or 16.

In an exemplary embodiment, I/O devices 18 and 20 may include a variety of forms of equipment connected to communication network 12 and accessible to a user. I/O devices 18 and 20 may be telephones (wireline or wireless), dial-up modems, cable modems, DSL (digital subscriber line) modems, phone sets, fax equipment, answering machines, set-top boxes, televisions, POS (point-of-sale) equipment, PBX (private branch exchange) systems, personal computers, laptop computers, personal digital assistants (PDAs), SDRs, other nascent technologies, or any other appropriate type or combination of communication equipment available to a user. I/O devices 18 and 20 may be equipped for connectivity to communication network 12 via a PSTN, DSLs, a cable network, a wireless network, or any other appropriate communications channel.

Referring now to FIG. 2, a block diagram of an exemplary embodiment of a telecommunication system 22 is shown. In the exemplary embodiment shown, system 22 preferably includes a PSTN 24 and cable head-end 26 in communication with cable distribution network 28. PSTN 24 may be in operable communication with host digital terminal (HDT) 30 and function to convert signals received from PSTN 24 for transmission over cable networks. Host digital terminal 30 and cable head-end 26 may be in communication with combiner 32. Combiner 32 may communicate data received from cable head-end 26 and/or PSTN 24 to cable distribution network 28. Cable distribution network 28 may further communicate data to network interface device 34 to a user via telephone 36, computer 38, television 40 or any other suitable I/O device. Cable head-end 26 may provide cable television programming and cable modem communications. Cable head-end 26 typically includes a cable modem termination system (not expressly shown) for sending and receiving digital cable modem signals.

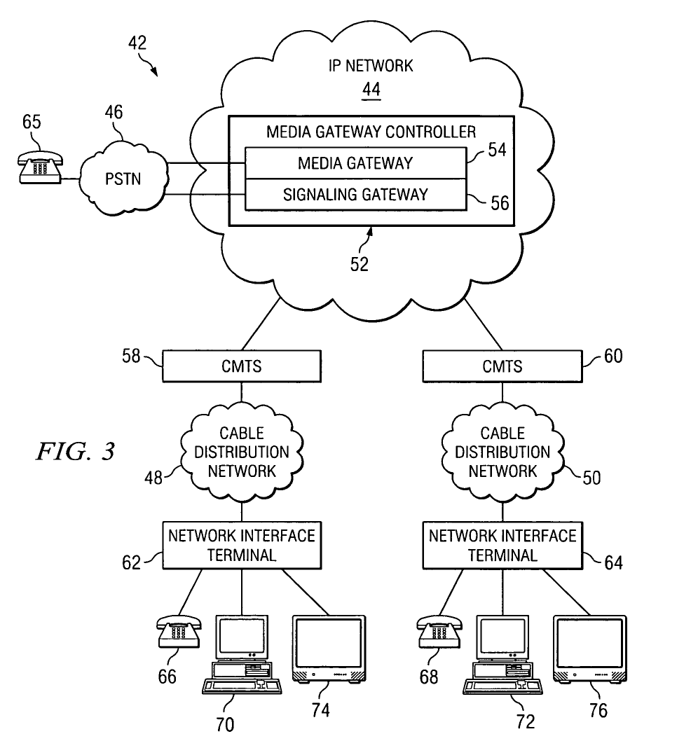

Referring next to FIG. 3, a block diagram of an exemplary embodiment of a telecommunication system 42 is shown. This exemplary embodiment generally includes interconnected IP network 44, PSTN 46, and cable distribution networks 48 and 50. IP network 44 may include media gateway controller 52, media gateway 54, and signaling gateway 56. Media gateway 54 and signaling gateway 56 may be in operative communication with PSTN 46 and facilitate communication of information therebetween. IP network 44 may further communicate with cable distribution networks 48 and 50 via cable modem termination systems (CMTS) 58 and 60, respectively. CMTS 58 and 60 may convert IP packets received from IP Network 44 for transmission on cable distribution networks 48 and 50 and convert signals received from cable distribution networks 48 and 50 into IP Packets for transmission to IP Network 44. Cable distribution networks 48 and 50 may communicate information with users via network interface terminals 62 and 64. Network interface terminals 62 and 64 may provide data services to users through I/O devices such as, telephones 66 and 68, computers 70 and 72, and televisions 74 and 76. One or more data services may also be provided to a user through PSTN 46 and one or more I/O devices such as telephone 65.

Telecommunication system 42 of FIG. 3 preferably allows transmission of services to be delivered to users where such services include, without limitation, voice over Internet protocol (“VoIP”), video over Internet, video-on-demand over broadband connections, and the ability to view television and film images as well as broadcasts. In addition, one of ordinary skill will appreciate that other embodiments can be deployed with many variations in the number and type of I/O devices, communication networks, the communication protocols, system topologies, and myriad other details without departing from the spirit and scope of the present invention.

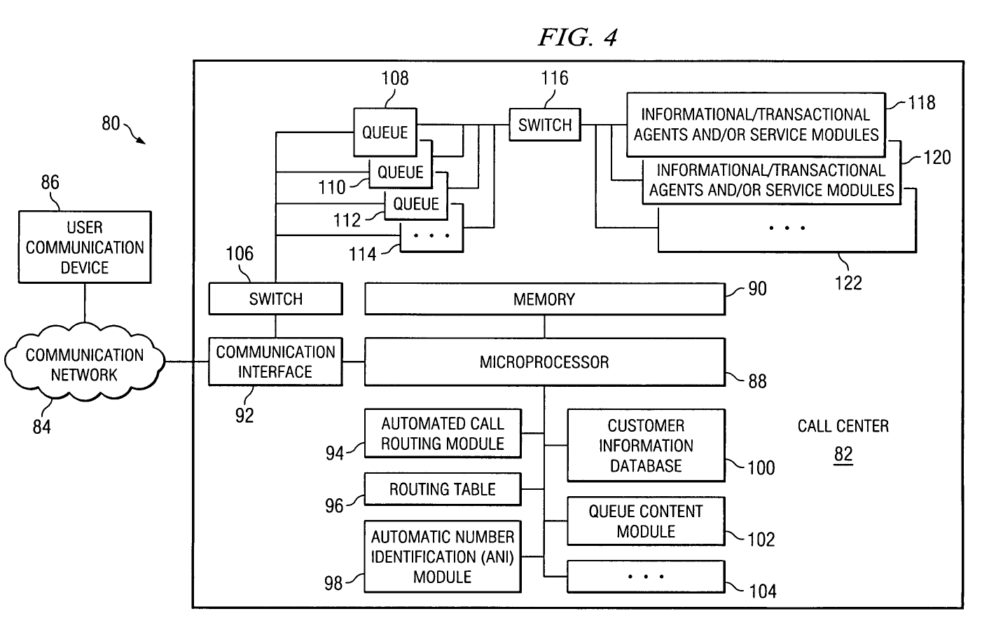

Referring now to FIG. 4, block diagram depicting one embodiment of a call center-to-user communication system is shown according to teachings of the present invention. In a preferred embodiment, system 80 of FIG. 4 preferably permits a user to maximize efficiencies in a customer service delivery call center through the utilization of targeted content presentations during periods in which a user is queued, awaiting support.

As illustrated in FIG. 4, system 80 preferably includes call center system 82. Call center system 82 is preferably communicatively coupled to communication network 84. Depending upon the specific implementation, communication network 84 may be implemented via one or more wireless and/or wireline communication technologies. In operation, call center system 82 preferably permits one or more users to access transactional or informational services available from call center system 82 through communication network 84 using one or more user communication devices 86 compatible with communication network 84.

In an exemplary implementation, call center system 82 may be implemented as a computing apparatus preferably including microprocessor 88 and memory 90. Microprocessor 88 and memory 90 preferably cooperate to execute and store, respectively, one or more instructions from one or more programs of instructions embodied in computer readable media.

Also preferably coupled to microprocessor 88 is communication interface 92. In one embodiment, communication interface 92 preferably enables call center system 82 to effectively communicate with one or more user communication devices 86, additional call center systems 82, as well as other devices connected to communication network 84. Call center system 82 may include a plurality of communication interfaces 92 such that a plurality of users may communicate with call center system 82 via communication network 84. Alternatively, communication interface 92 may be operable to receive a plurality of user communication connections via communication network 84 such that call center system 82 may respond to a plurality of user informational and/or transactional requests.

In one embodiment, call center system 82 may leverage a plurality of technologies to effect the delivery of targeted content to queued users according to teachings of the present invention. In one aspect, automated call routing module 94 may be included in call center system 82, operably coupled to microprocessor 88. In an exemplary embodiment, automated call routing module 94 is preferably operable to interpret one or more user utterances and/or one or more user DTMF signals or inputs directed to user selection of an available call center system 82 transaction. Automated call routing module 94 may employ a variety of technologies to decipher user utterances to ascertain or determine user transaction selections and/or user intent.

After receiving a user utterance and/or DTMF input, automated call routing module 94 preferably identifies or determines the user selected transaction and leverages routing table 96 to determine a routing destination operable to facilitate the selected transaction. In one embodiment, routing table 96 may include a plurality of service agents or modules operable to support users in the performance of one or more transactions and/or provide one or more aspects of information requested by a user. Service agents or modules which may be employed in call center system 82 include live agents, automated transactional or informational modules, as well as combinations thereof. In addition, routing table 96 may include routing destinations available from within call center system 82 as well as routing destinations associated with service agents or modules external to call center system 82, such as one or more service agents or modules available via communication network 84.

Automatic number identification (ANI) module 98 may also be included in call center system 82, operably coupled to microprocessor 88. In one implementation of the present invention, content delivered to a user while waiting in a queue is preferably targeted specifically to the waiting user. Such targeted or user-centric content may be compiled by first identifying the user for which content is being compiled. As such, ANI module 98 may be employed to ascertain one or more aspects of a communication connection between a user and call center system 82, such as a communication connection between user communication device 86 via communication network 84 with call center system 82. In one aspect, ANI module 98 may be employed to obtain the telephone number from which a user is contacting call center system 82. From a user telephone number, various information concerning the current user may be gathered and compiled, such user related data preferably maintained by call center system 82 or in one or more information storage and/or retrieval devices communicatively coupled to call center system 82. In an alternate embodiment, ANI module 98 may be used in conjunction with one or more system prompts which request identification information directly from the user such as via one or more user utterances, DTMF input signals or combination thereof.

Having obtained one or more items of identification information for a user communicatively connected to call center system 82, customer information database 100 may be accessed and leveraged in the compilation and gathering of targeted, user-centric queue-time content. Customer information database 100 may include such user information as information pertaining to one or more user accounts, one or more aspects of user demographics, a call history associated with the user, as well as myriad other bits of information which may be useful in the provision and delivery of targeted queue-time content.

Call center system 82 may also include queue content module 102 and be operable to leverage the same in the development and delivery of targeted, queue-time content to waiting users. Queue content module 102 may include a number of scripts, as well as script contents associated with one or more informational or transactional agents or service modules of call center system 82. In one embodiment, queue content module 102 preferably cooperates with customer information database 100 in the compilation or generation of user-centric, queue-time content. For example, if a user were to contact call center system 82 and provide the user utterance “I have a question about my bill”, automated call routing module 94 may place the customer in an informational or transactional service module associated with user billing. Having identified the current user using ANI module 98 and/or one or more call center system 82 prompts, queue content module 102 and customer information database 100 may cooperate to create targeted content for presentation to the user during the period in which the user is queued and awaiting service from a call center system 82 billing agent or service module. In such an example, such targeted content compiled for and presented to the user may include a user account balance, last payment amount, next payment amount, due date for the next payment, a listing of services associated with a user account, as well as myriad other information. In addition, such targeted content may include the presentation of an option for the current user to proceed to an automated payment system where the user would be permitted to pay on the account, such as payment of the account balance, next payment, etc.

In another example, a user may contact call center system 82 and, as a result of one or more user utterances and/or one or more DTMF input signals, be routed to an account services agent or service module. While queued in the account services agent or service module, the user may be presented with a listing of the optional services associated with the user's account. In addition, the user may be presented with the option to proceed to one or more “How To Use” modules associated with the optional services available on a user account. Further, a listing of alternative available option services which can be added to a user account may also be presented during the time which the user is queued at an account services agent or service module. Still further, the user may be offered an option of proceeding to a transactional agent or service module operable to permit the user to add one or more additional optional services to their current service as indicated in the presented user account information. Additional modules 104 may also be included in call center 82 to provide expanded delivery of targeted, queue-time content as well as perform other services.

From the teachings of the present invention and disclosure, alternative embodiments of the compilation and presentation of targeted, user-centric, queue-time content may be developed without departing from the spirit and scope of the teachings of the present invention. Additional detail concerning the identification of users, compilation and presentation of user-centric, and targeted, queue-time content is discussed below.

As described above, automated call routing module 94 and routing table 96 preferably cooperate to determine an appropriate routing destination for a user based on a user selected informational or transactional option. Following the identification of a preferred or appropriate routing destination, microprocessor 88 may cooperate with communication interface 92 and switch 106 to direct and/or connect a user to a queue 108, 110, 112 and 114, optionally coupled through switch 116 to one or more informational/transactional agents and/or service modules 118, 120 and 122. In one aspect, time spent by a user in queue 108, 110, 112 or 114 may be determined by the resources available at informational/transactional agents and/or service modules 118, 120 and 122. In certain circumstances, connection of a user to one or more call center system 82 informational/transactional agents and/or service modules 118, 120 and 122 may include the user bypassing queues 108, 110, 112 or 114 as the resources available at informational/transactional agents and/or service modules 118, 120 or 122 are substantially immediately available. The resources available at informational/transactional agents and/or service modules 118, 120 and/or 122 may include live support, one or more automated processes or agents and/or combinations thereof. In addition, one or more informational/transactional agents and/or service modules may be implemented external to call center system 82, such as one or more informational/transactional agents and/or service modules communicatively coupled to call center system 82 via communication network 84.

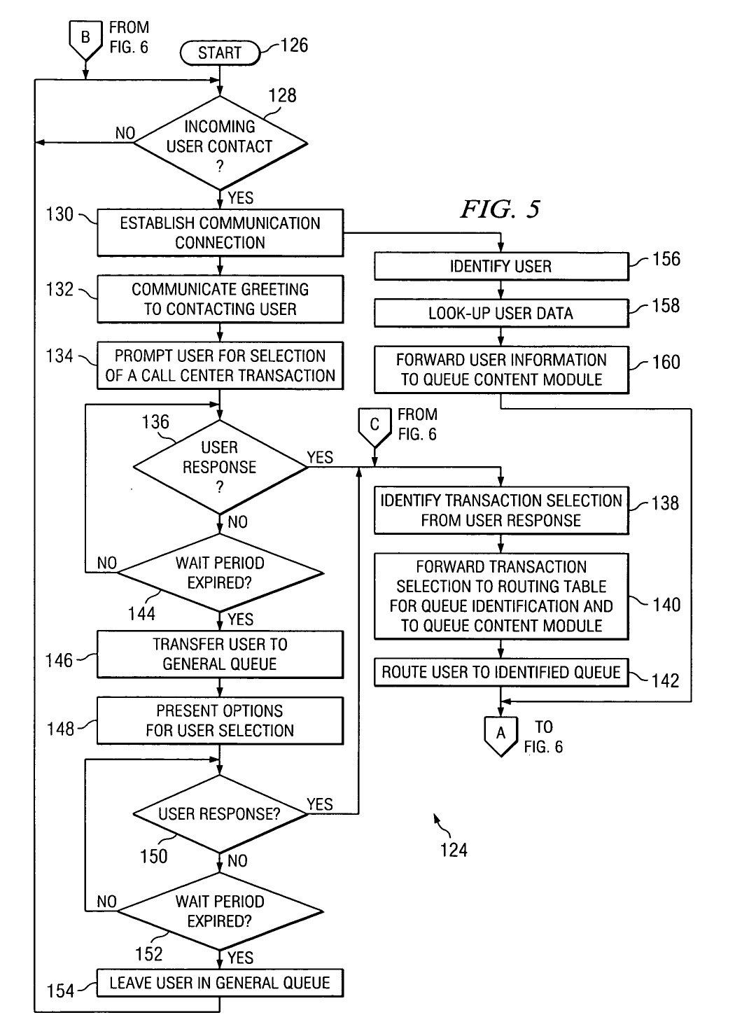

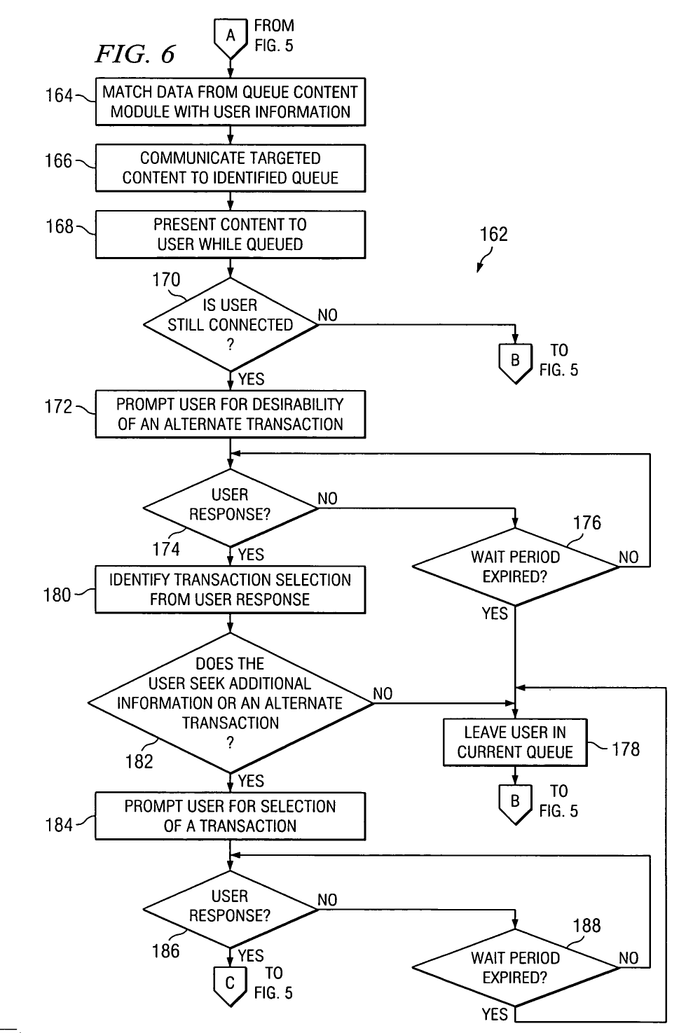

Referring now to FIG. 5, one embodiment of a method for delivering targeted content to queued users is shown according to teachings of the present invention. In one aspect, teachings of the present invention preferably permit a user to accomplish tasks while waiting in call center queues. The present invention may reduce call center costs by shedding calls from transactional hold queues or by reducing the amount of time a user spends interacting with a customer service representative. Another benefit that may flow from teachings of the present invention is an improved customer satisfaction rating resulting from customer ability to perform tasks while waiting in a queue. Other benefits, advantages and embodiments of the present invention may be derived from the instant disclosure without departing from its spirit and scope.

Method 124 of FIG. 5 preferably begins at 126 and proceeds to 128 where a user to call center contact is preferably awaited. If at 128 an incoming user contact is not detected, method 124 preferably remains in a wait state at 128. As suggested above, one or more users may contact call center system 82 via communication network 84 using one or more user communication devices 86.

Upon detection of an incoming user contact at 128, method 124 preferably proceeds to 130 where a communication connection may be established with the contacting user. For example, communication interface 92 of call center system 82 may receive an incoming call on communication network 84 from a user communication device 86. Once a communication connection has been established with the contacting user at 130, method 124 preferably proceeds to 132. At 132, call center system 82 may communicate a greeting welcoming a contacting user to the services of call center system 82. In addition, the greeting communicated to the user at 132 may include one or more instructions concerning the operation of one or more informational/transactional agents and/or service modules available via call center system 82 as well as the selection of one or more informational/transactional agents and/or service modules.

Following communication of a greeting to the user at 132, method 124 preferably proceeds to 134. At 134, the user may be prompted for selection of an available call center system 82 transaction. As mentioned above, informational/transactional agents and/or service modules 118, 120 and 122 may be available internally from call center system 82 as well as external to call center system 82, such as one or more informational/transactional agents and/or service modules communicatively coupled to call center system 82 via communication network 84. At 134, the user may be prompted for selection of a call center transaction via a user utterance, a DTMF input or a combination thereof. Alternative selection means for permitting a user to select an available call center transaction may also be utilized without departing from the spirit and scope of the teachings of the present invention.

At 136, a user response to the prompt for selection of an available call center option is preferably awaited. If at 136 a user response is detected, method 124 preferably proceeds to 138 where a transaction selection may be identified from the user's response. As mentioned above, an automated call routing module may be leveraged in an effort to discern user utterances received in response to a prompt for selection of a call center transaction. Other embodiments of identifying a call center transaction from a user response may be employed without departing from the spirit and scope of teachings of the present invention.

After the identification of a user selected transaction at 138, method 124 preferably proceeds to 140. At 140, the transaction selection is preferably forwarded to routing table 96 to facilitate determination of an appropriate routing destination for the user to receive support for their selected transaction. In addition, the identified transaction selection is preferably also routed to queue content module 102 such that targeted, queue-time content for the current user may be developed, compiled and eventually presented to the user during a period in which the user waits in a queue associated with their transaction selection. Following the forwarding of the transaction selection to routing table 96 and queue content module 102, the user is preferably routed to the appropriate queue and/or routing destination identified from the transaction selection in routing table 96.

If at 136 a user response is not detected, method 124 preferably proceeds to 144 where a wait period may be reviewed. In one embodiment of the present invention, call center system 82 may be configured to wait a predetermined period of time for a user to respond to a prompt for selection of a call center transaction at 134. If at 144 it is determined that the predetermined wait period has not expired, method 124 may return to 136 to await a user response.

If at 144 it is determined that the predetermined wait period for call center system 82 had expired, method 124 preferably proceeds to 146 where the contacting user may be transferred to a general queue of call center system 82. Once the contacting user has been placed in a general queue of call center system 82, method 124 may proceed to 148, where one or more options identifying information and/or transactions available from call center system 82 may be presented to the user for selection therefrom.

At 150, a user response, such as a user utterance and/or one or more DTMF inputs, may be awaited. If at 150 a user response is detected, method 124 preferably proceeds to 138 where the user's transaction selection may be identified from the user's response. Alternatively, if at 150 it is determined that a user response is not detected, method 124 preferably proceeds to 152 where an evaluation or determination as to whether a predetermined wait period has yet to expire may be performed. If a user has not responded within a call center system 82 predetermined wait period, method 124 preferably proceeds to 154 where the user may be left in a general queue of call center system 82 and where the user may await general service availability from, for example, the next available customer service representative. Method 124 then preferably returns to 128 where contact from a next user may be awaited.

In connection with prompting a user for selection of an available call center system 82 transaction, one or more operations are preferably performed in an effort to ascertain one or more items of user identification information. Accordingly, following the establishment of a communication connection at 130, method 124 preferably provides, at 156, for one or more operations to be performed to identify the user. As mentioned above, one or more automated mechanisms may be employed to identify the user as well as the communication of one or more prompts in an effort to elicit identification information from the user. Accordingly, ANI module 98 may be employed to extract data from a user communication connection with call center system 82 which will provide information based upon which call center system 82 may access customer information database 100 to gather user data. In an alternate embodiment, method 124, at 156, may prompt the user for entry of a user account number, telephone number, Social Security number, as well as myriad other information available from and identifying the user.

Following the acquisition of one or more items of user identification information at 156 and the identification of the user, method 124 preferably proceeds to 158 where one or more components of user data may be accessed. As mentioned above, call center system 82 may maintain one or more customer information databases 100 including various aspects of data concerning users known to call center system 82. Once one or more items of information concerning the identified user have been obtained, method 124 preferably provides for such user information to be forwarded to queue content module 102 such that targeted, queue-time content may be compiled for presentation to the user during a period in which a user waits in a queue for support. From 160, method 124 preferably proceeds to 164 of method 162.

At 164 of method 162 illustrated in FIG. 6, an algorithm designed to match data from queue content module 102 with user information, such as user information obtained from customer information database 100 may be executed. As described above, operations preferably performed at 164 may be directed to determining which aspects of information associated with a user should be communicated while the user remains in a queue based, at least in part, on the particular queue in which the user is anticipated to be waiting. For example, if the user is anticipated to be waiting in a “billing” queue, user information which may be appropriate to communicate to the user while waiting in the billing queue may include, but is not limited to, a user account balance, last payment amount or date, next payment amount or date, minimum payment due, mailing address for payment submission, as well as one or more options enabling the user to make a payment, add additional services, or perform any other available transaction offered by call center system 82. A number of methods may be employed to determine content appropriate for communication and targeted for users in various queues available from call center system 82. In one embodiment, the transactions performed by call center system 82 may be tracked to identify the most frequently requested information concerning a user account. In one such example, call center system 82 may be configured to communicate the five most requested options regarding customer billing inquiries in that time in which a user is waiting in a billing services queue. Alternative methods of selecting targeted content, as well as the means for the compilation and presentation of targeted content may be employed without departing from the spirit and scope of teachings of the present invention.

After compiling or gathering the user targeted, queue-time content at 164, method 162 preferably proceeds to 166 where the targeted content is preferably communicated to the queue in which the user waits. At 168, the targeted content communicated to the queue in which the user waits is preferably presented to the user for consumption.

Following presentation of targeted queue-time content while the user remains queued, method 162 preferably proceeds to 170 to determine if the user remains connected with call center system 82. For example, if a user were waiting in a billing services queue and the user was presented with the information sought from the billing services agent or service module, the user may elect to abandon the communication connection with call center system 82 as the targeted, queue-time content presented to the queued user served to complete the transaction or information acquisition on the instant occasion.

If at 170 it is determined that the user has been shed from the queue, method 162 preferably proceeds to 128 where a next communication contact with a user may be awaited. Alternatively, if at 170 it is determined that the user remains online in the current queue, method 162 preferably proceeds to 172 where the user may be prompted for the desirability of an alternate transaction.

At 174, a user response to the prompt for desirability of an alternate transaction may be awaited. If a user response is not detected, method 162 preferably proceeds to 176 where a determination may be made as to whether a predetermined call center system 82 wait period has expired. If at 176 it is determined the predetermined wait period has not expired, method 162 preferably returns to 174 where a user response may again be awaited. Alternatively, if at 176 it is determined that the call center system 82 predetermined wait period has expired, method 162 preferably proceeds to 178 where the user may be left in the current queue, based on the assumption that the user remains in that queue from which the user believes the desired service or information may be obtained. Upon leaving the user in their current queue at 178, method 162 preferably returns to 128 of method 124 where contact from a next user may be awaited.

If at 174 a user response to the prompt for desirability of an alternate transaction is observed, method 162 preferably proceeds to 180 where the transaction from the user response is preferably identified. At 182, the transaction selection received from the user is preferably evaluated to determine whether the user seeks additional information or an alternate transaction. If the user seeks additional information deliverable by an information/transactional agent or service module associated with the queue in which the user current waits, method 162 may proceed to 178 where the user may be left to await service from the informational/transactional agent or service module associated with the current queue before returning to 128 of method 124 where a next user contact may be awaited.

If at 182 it is determined from the identification of the transaction selection from the user response to the prompt for desirability of an alternate transaction is user selection of an alternate transaction, method 162 preferably proceeds to 184. At 184, the user may be prompted for their selection of an alternate transaction. After prompting the user for selection of a transaction at 184, method 162 preferably proceeds to 186 where a user response to the prompt may be awaited. If a user response is not detected, method 162 may proceed to 188 where the passing of a wait period may be evaluated. If a user response is not detected after the expiration of a call center system 82 predetermined wait period at 188, the user may be left in the current queue at 178 before method 162 proceeds to 128 of method 124 where the next contact from a next user may be awaited. Alternatively, if a user response is detected at 186 prior to the expiration of a predetermined wait period, method 162 may proceed to 138 of method 124 where the transaction selection and the user response may be identified generally as described above and the user again may be presented with targeted, queue-time content related to the next transaction sought by the user.

Although the disclosed embodiments have been described in detail, it should be understood that various changes, substitutions and alterations can be made to the embodiments without departing from their spirit and scope.

1. A method for delivering targeted content to a queued call center user, comprising:
establishing a communication connection with a user;
prompting the user for selection of an available call center transaction;
obtaining one or more items of user identification information;
analyzing a user utterance to ascertain a user selected call center transaction;
identifying a call center routing destination based on the user selected call center transaction;
determining whether call center transaction support is available at the identified call center routing destination or whether the user is to be placed in a queue associated with the identified call center routing destination;
routing the user to the identified routing destination;
if the user is to be placed in a queue associated with the identified call center routing destination, compiling information related to the identified call center routing destination associated with the user selected call center transaction and the one or more items of user identification information;
communicating the compiled information to the queued user while the user is queued at the identified call center routing destination; and
responding to user selection of a selectable option presented to the queued user by repeating the identifying, determining, routing, compiling and communicating operations.

2. Software for delivering content targeted to a queued user, the software embodied in computer readable media and when executed operable to:
gather content for presentation to a user based on a user selected call center transaction and one or more items of information identifying the user; and
present the content to the user during a period in which the user is placed in a queue associated with a transaction service routing destination associated with the user selected call center transaction.

3. The software of claim 2, further operable to match content from a transaction content database with the information identifying the user to provide customized content to the user while queued.

4. The software of claim 2, further operable to analyze a user utterance responsive to a prompt for user selection of a call center transaction.

5. The software of claim 2, further operable to identify the user using one or more automatic number identification (ANI) services.

6. The software of claim 2, further operable to permit user selection of an option included in the content presented to the queued user, the option operable to enable user performance of an alternate call center transaction.

7. The software of claim 6, further operable to:
gather alternate content for presentation to the user based on the alternate call center transaction selected by the user and the information identifying the user; and
present the alternate content to the user during a period in which the user is placed in a queue associated with the transaction service routing destination associated with the alternate call center transaction selection.

8. The software of claim 2, further operable to:
identify the transaction service routing destination associated with the selected call center transaction; and
determine whether the user will be queued when routed to identified call center transaction service routing destination.

9. A system for delivering targeted content to a queued call center user, comprising:
at least one processor;
memory operably associated with the processor;
a communication interface operably associated with the processor and the memory; and
a program of instructions storable in the memory and executable by the processor, the program of instructions operable to present targeted content to a user waiting in a transaction service queue, the targeted content selected in accordance with the transaction service queue in which the user is queued and one or more aspects of user identification information.

10. The system of claim 9, further comprising the program of instructions operable to:
prompt the user for selection of a call center transaction; and
evaluate a user utterance responsive to the prompt to identify a transaction selection.

11. The system of claim 9, further comprising the program of instructions operable to access a routing table to identify a routing destination for a transaction service associated with a user transaction selection.

12. The system of claim 11, further comprising the program of instructions operable to:
determine availability of support at the routing destination; and
compile the targeted content if the user is expected to be queued for support when routed to the identified routing destination.

13. The system of claim 9, further comprising the program of instructions operable to analyze the user identification information and one or more aspects of the transaction service queue to extract user and transaction targeted content from an associated task content database.

14. The system of claim 9, further comprising an automated number identification (ANI) module operably associated with the communication interface, the ANI module operable to ascertain one or more items of information identifying the user from a communication connection between the user and the call center.

15. The system of claim 9, further comprising the program of instructions operable to:
acknowledge user selection of an option included in the targeted content;
access a routing table to identify a transaction service associated with the user selected option; and
present targeted content to the user based on the option selection and the transaction service associated with the selected option while the user is queued for support from the option transaction service.

16. A method for delivering queue related content to a waiting user, comprising:
accessing information associated with one or more user accounts;
identifying a transaction service operable to assist a user in performing one or more selected transactions;
queuing the user in a queue associated with the identified transaction service; and
presenting to the queued information concerning the one or more user accounts and the identified transaction service.

17. The method of claim 16, further comprising:
permitting user selection of an option included in the information presented to the waiting user, the option operable to enable user performance of an alternate call center transaction;
gathering alternate information for presentation to the user based on the alternate call center transaction selected by the user and information associated with one or more user accounts; and
presenting the alternate information to the user during a period in which the user is placed in a queue of a transaction service routing destination associated with the alternate call center transaction selection.

18. The method of claim 16, further comprising analyzing a user utterance or DTMF response to a call center system prompt to identify a user selected transaction.

19. The method of claim 16, further comprising matching content from a task content database to one or more aspects of the user account information and the transaction queue associated with the identified service.

20. The method of claim 16, further comprising determining whether support available from the transaction service will be available substantially immediately or whether the user is expected to be queued when routed to a routing destination associated with the transaction service.

21. The method of claim 16, further comprising:
receiving a user utterance or DTMF input selecting a transaction option presented in the targeted content; and
evaluating the user selection to identify the selected transaction option;
identifying a call center routing destination for the selected transaction option;
routing the user to a queue associated with the selected transaction option routing destination; and
presenting targeted content to the user while queued, the targeted content including information from a task content database matching the transaction option selection and one or more aspects of the user account information.
